(19) United States
(12) Patent Application Publication
(10) Pub. No.: US 2003/0081293 A1
(43) Pub. Date: May 1, 2003

(54) Optical communications system and method

(75) Inventors: Lowell L. Wood JR., Livermore, CA (US); Roderick A. Hyde, Livermore, CA (US)

Correspondence Address: William A. Webb, c/o Brinks Hofer Gilson & Lione, P.O. Box 10395, Chicago, IL, 60610, US

(73) Assignee: Optical DataStreams, LLC.

(21) Appl. No.: 10/040,284

(22) Filed: Oct. 26, 2001

(51) Int. Cl. H04B 10/00

(52) U.S. Cl. 359/172; 359/152

(57) ABSTRACT

An optical communication system includes a master unit, one or more beam-deflectors, and one or more client units, interconnected by free-space beam path. Methods are described for automatically aligning the various components of the optical circuit, without human intervention or assistance, and without advance knowledge of the location of individual components in space.

### BACKGROUND

This invention relates to optical communications systems that send and receive optical signals over freespace beam paths.

It is highly useful to have means of transmitting data through freespace near the Earth's surface in a manner which doesn't congest the portion of the electromagnetic spectrum which is available to support communications, which is capable of transmitting data at moderate to high bandwidth (e.g., >10⁴ bit/second), and which is economical and safe. The portion of the electromagnetic spectrum with freespace wavelength λ<10 micrometers, where λ is the wavelength-in-vacuum, is particularly attractive in these respects; radiation in this portion of the spectrum is referred to as ‘optical’.

### BRIEF SUMMARY

The optical communications systems described below signal with optical radiation through freespace between a transmitting location and a receiving location without a direct line-of-sight being required between the two. These systems automatically align themselves for freespace optical communication without a human technician or engineer being required to determine or to know either the absolute or the relative locations of the transmitter and the receiver. No significant human participation is required in either the initial establishment or the maintenance-in-operation of the optical circuit between the transmitter and the receiver.

### BRIEF DESCRIPTION OF THE DRAWINGS

FIG. 1 is a block diagram of an optical communication system that incorporates a preferred embodiment of this invention.

FIG. 2 is a more detailed block diagram of the master station 12 of FIG. 1.

FIG. 3 is a more detailed block diagram of the relay station 14 of FIG. 1.

FIG. 4 is a more detailed block diagram of one of the master units 30 of FIG. 2.

FIG. 5 is a block diagram of the client unit 16 of FIG. 1.

FIG. 6 is a more detailed block diagram of one of the beam-deflectors 40 of FIG. 3.

FIG. 7 is a sectional diagram of an optical system suitable for use as the optical beam director 50 of FIG. 4 or the optical beam director 70 of FIG. 5.

FIG. 8 is a side view of one of the beam-deflectors 40 of FIG. 3.

FIG. 9 is a side view of an alternative embodiment of a beam deflector.

FIG. 9a is a side view in partial cutaway of the beam deflecting element 162 of FIG. 9.

FIG. 10 is a front view of another embodiment of a beam-deflector.

FIGS. 11 and 12 are schematic representations of two alternative steering systems.

FIG. 13 is a front view of an optical beam director, including a wide-angle photodiode.

FIG. 14 is a block diagram of an automatic alignment method implemented by the system of FIG. 1.

FIGS. 15a, b, c, and d are schematic diagrams illustrating successive phases of the alignment process of FIG. 14 in one example.

FIG. 16 is a block diagram of a two-phase search pattern suitable for use in the method of FIG. 14.

FIG. 17 is a schematic diagram of the optical communication system 10 of FIG. 1 as installed in an urban setting.

### DETAILED DESCRIPTION OF THE DRAWINGS

General Overview

The optical communication systems described below establish and thereafter operate freespace optical communication circuits between one or more master units and one or more client units. These communication circuits are incorporated within the global digital network, and the master units are generally “upstream” within the global digital network compared to “downstream” client units. While the data-flow may be predominantly (or entirely) from the master to the client(s), (forward traffic), the disclosed systems also support reverse data flows from the client(s) to the master(s) (reverse traffic).

Of course, optical communication systems of the type described below may include more than one level of master and client units. For example, a first client unit for a given master unit may be a transceiver that acts as a master unit for another, downstream client unit. Similarly a given master unit may be a transceiver that acts as a client unit for another, upstream master unit.

Communication between a master and a client is carried out via individual optical communication circuits. Each optical circuit connects one client unit to one master unit through a free space air-path.

The communication circuits described below are established and maintained as long-duration, semi-permanent links between a master and a client; they are not established only for the length of individual messages as in previous systems (such as Douchet, U.S. Pat. No. 5,786,923). In the system described below, the master and the client cooperate to establish and thereafter maintain a semi-permanent communication circuit between themselves, one which exists for a much longer time than the timespan of individual message sequences.

Each forward-traffic communication channel includes a modulated light source in the master, which acts to generate an optical signal carrying information. This optical signal is then transmitted into free space by an optical beam-director. Upon arriving at the client unit, this optical beam enters an optical receiver, wherein its optical signal is converted to electrical form in a photodetector and is then demodulated and made available for use by the client's user.

If present, a reverse-traffic communication channel operates in a fundamentally similar, but reversed, fashion; in this case, the circuit is said to be bi-directional, and the master and client units each contain similar (typically, identical) optical transceivers. Each optical transceiver contains a modulated optical source, a beam-director, an optical receiver, a photodetector, and a demodulator.

The signal-bearing optical beam travels between the master and client units via a free space air-path. In its simplest form, this transit may be via a single direct-line-of-sight link. However, one embodiment of the present invention provides for indirect, non-line-of-site linkage between the master and client units. This is achieved by incorporating one or more optical beam-deflectors within the optical circuit. The optical beam travels from the master unit to one optical beam-deflector, optionally to a sequence of other beam-deflectors, and eventually to the client unit. While each transit within the air-path is a direct line-of-site link, the overall transit need not be, thereby enabling an optical circuit between master and client units that are not in sight of each other. (For notational clarity, we refer below to the first beam-deflector (closest to the master unit) in a communication circuit as a level 1 relay, the second as a level 2 relay, etc.). The optical beam-deflectors described below do not receive and then retransmit beams, but simply physically redirect them.

The system described below includes two different classes of devices, optical units to implement communication circuits, and support stations to house the optical units. Each communication circuit is implemented by a master unit, an optional sequence of one or more optical beam-deflectors, and a client unit. These units are mounted and supported in corresponding stations; a circuit thus will have a master-station at one end, a sequence of one or more relay-stations (containing beam-deflectors) in its mid-portion, and a client-station at its other end. The purpose of these stations is to provide common support functions (such as mechanical housing, electrical power, command and communications support, etc.) to the unit(s) within them. Each master-station may contain more than one master unit, each relay-station may contain more than one optical beam-deflector, and each client-station may contain more than one client unit, i.e., each such station-type may implement portions of more than a single communications circuit

In one embodiment of the present invention, each communication circuit is entirely separate from all others, having a dedicated master unit, optical beam-deflectors, and client unit.

In another embodiment, multiple communication circuits may share common optical units for part or all of the beam-path. As one example of this embodiment, several circuits can share the same master unit. The optical signals for these circuits are multiplexed together (by, for example, time or wavelength methods) and travel together to a common level 1 relay-station. At this location they may continue to travel together, sharing a common optical beam-deflector, or they may be handled by multiple optical beam-deflectors, and thereafter be split apart into physically separate beams. In this embodiment, since the optical beam-deflectors do not demodulate or demodulate the optical signals, but simply physically split and redirect them, each involved client unit handles the full, multiplexed-together signal beam; i.e., the master unit sends the same optical signal to multiple client units. Each client demodulates the beam (by, for example, time or wavelength methods) and need process only the portion of the signal intended for itself.

### SPECIFIC EXAMPLES

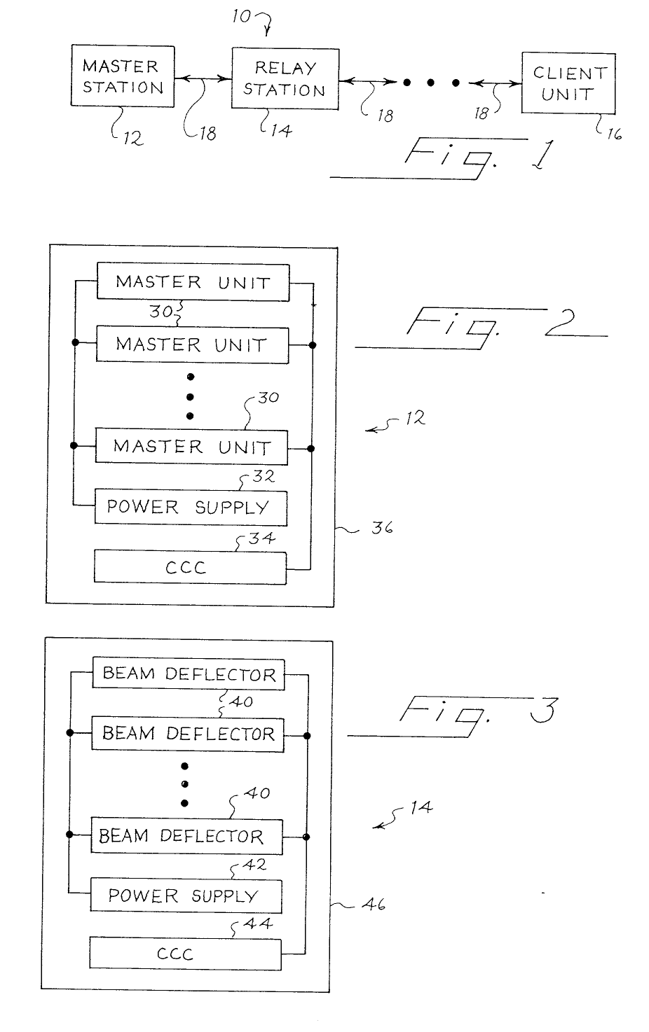

Turning now to the drawings, FIG. 1 shows a block diagram of an optical communication system 10 that uses optical beams transmitted in free space to transmit data between a master station 12 and a client unit 16 by way of one or more relay stations 14. In FIG. 1 the free-space beam paths are indicated by the reference numeral 18. In many applications, it is desirable to be able to carry out bi-directional communication. Accordingly, in a preferred embodiment of the present invention both the master and the client units of the optical circuit contain optical transceivers, each of which is capable of both sending and receiving optical signals.

As discussed in detail below, in this non-limiting example, the master station includes a plurality of steerable optical transceivers, each relay station 14 includes multiple beam-deflectors, and the client unit 16 includes a steerable optical transceiver. Optical beams on the free-space beam paths 18 transmit digital data from the master station 12 to the client unit 16, and from the client unit 16 to the master station 12. The advantage provided by the beam-deflectors is that they enable optical circuits between master units and client units which are not directly visible to each other.

FIG. 2 provides a more detailed block diagram of the master station 12, which includes multiple master units 30 enclosed by a mechanical enclosure 36. The master units 30 of the master station 12 are powered by electrical power from a power supply 32, and the master units 30 are controlled by and transmit data via a command, control and communication system (CCC system) 34. For example, the master station 12 can include four, eight or sixteen master units 30. The CCC system 34 may for example be connected to the Internet, and as described below it may include low-power, radio-frequency communication systems to facilitate coordination between the master unit 12 and the other components of the system 10. By way of example, the power supply 32 can include a conventional battery and voltage source powered by external line current.

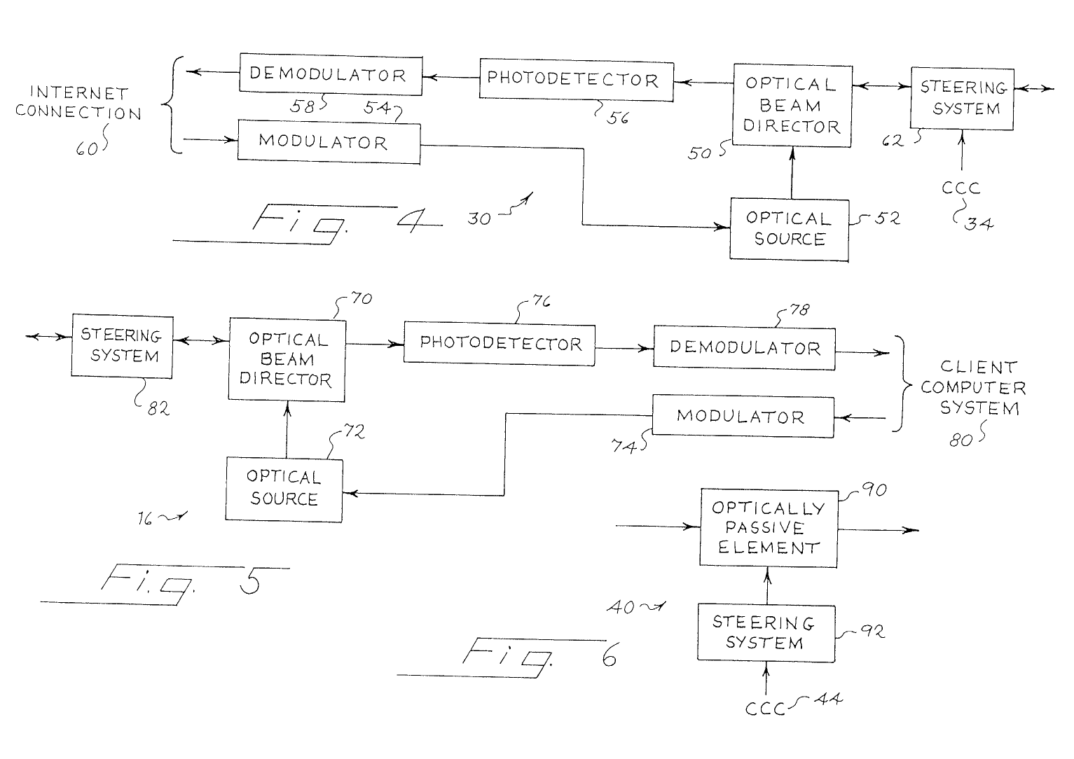

As shown in FIG. 3, the relay station 14 may include multiple beam-deflectors 40, all housed within a common mechanical enclosure 46, all powered by a single power supply 42 and all controlled by a single CCC system 44.

The arrangement shown in FIGS. 2 and 3 will in many cases reduce system cost, because multiple master units 30 share a single power supply 32, CCC system 34, and enclosure 36, and multiple beam-deflectors 40 share a single power supply 42, CCC system 44, and enclosure 46. However, in some cases it may be preferred to include only a single master unit 30 within each master station 12 and only a single beam-deflector 40 within each relay station 14.

FIG. 4 shows a more detailed block diagram of one of the master units 30 of FIG. 2. As shown in FIG. 4, each master unit 30 in this example takes the form of a transceiver that both transmits a modulated optical beam and receives a coaxial modulated optical beam. Optical signals transmitted by the optical beam director 50 are generated by an optical source 52 that is controlled by a modulator 54. Optical signals received by the optical beam director 50 are detected by a photodetector 56 and demodulated by demodulator 58. Output signals of the demodulator 58 and control signals for the modulator 54 may be sent to and received from an Internet connection 60, respectively.

As described in greater detail below, the optical beams sent and received by the optical beam director 50 are preferably narrow-angle beams having a narrow spectral bandwidth. These optical beams are preferably steered as described below by a steering system 62 that for example may physically steer the optical beam director 50 as commanded by the CCC system 34. This steering system 62 preferably steers the beam over a solid angle that extends over two angular dimensions. As an alternative, the elements described below in FIGS. 8-12 can be used to steer the optical beams transmitted from and received by the optical beam director 50.

The master unit 30 of FIG. 4 includes both an optical receiver and a coaxial optical transmitter. The optical transmitter generates and then projects in a specified direction a reasonably high quality (e.g., low intrinsic divergence) beam of reasonably narrow spectral width upon which useful information has been impressed by an appropriate modulation scheme. For example, such modulation may be accomplished by using a data bit string of ones and zeroes to turn on and off, respectively, the current drive to the optical source 52, thereby effecting pulse coded modulation of the light beam generated by the optical source 52. More sophisticated schemes, e.g., schemes, which more efficiently exploit the dynamic range of the beam's intensity to impress more information onto the beam, may be preferable in some circumstances.

The optical receiver included in the master unit 30 receives a reasonably high spatial quality beam of reasonably narrow spectral width upon which useful information has been impressed, and directs this beam onto the photodetector 56. The photodetector 56 converts the optical signal into an electrical signal, and can for example be implemented as a photodiode. For example, if the incoming light beam were pulse code modulated, the output from the photodetector 56 would be a sequence of high- and low-voltage or current pulses, thereby reproducing in the optical circuit's receiver the signal that was employed to modulate the generated optical beam prior to its emission by the circuit's transmitter.

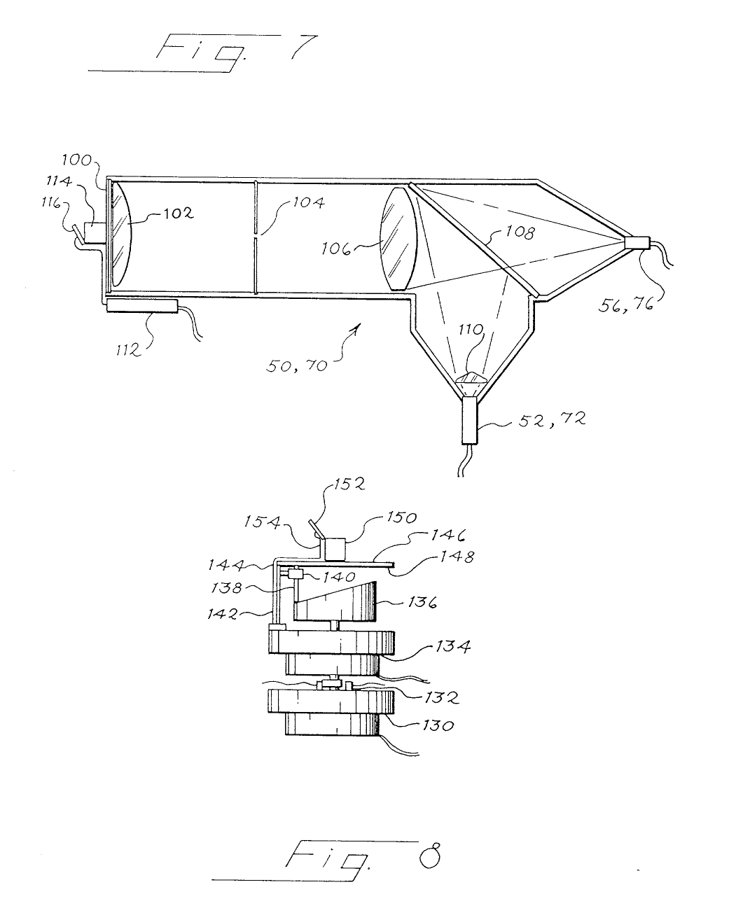

FIG. 5 shows a more detailed block diagram of the client unit 16 of FIG. 1. The client unit 16 includes an optical transceiver, that in this example includes an optical beam director 70, an optical source 72, a modulator 74, a photodetector 76, and a demodulator 78. The elements 70-78 may correspond to the elements 50-58 described above in conjunction with FIG. 4, and in fact the same optical system can be used for both the client unit 16 and the master unit 30. The modulator 74 and a demodulator 78 are coupled with a client computer system 80, e.g. via a USB connection. The optical beam director 70 is steered over two degrees of angular freedom by a steering system 82 that is controlled by an associated control system.

FIG. 6 provides a more detailed block diagram of one of the beam-deflectors 40 included in the relay station 14 of FIG. 3. As shown in FIG. 16, the beam-deflector 40 includes an optically passive element 90 such as a mirror, and a steering system 92 that steers the optically passive element 90 through a solid angle that extends over two angular degrees of freedom, under the control of the CCC system 44.

The role of the optical beam-deflectors is to accept an input beam from one unit of the optical circuit and to change its direction, sending the output beam to another unit of the optical circuit. The beam-deflectors described below operate by simple angular redirection of the input beam, not by active processes such as demodulation of the input beam followed by remodulation of the signal onto a new output beam. The angularly controlled redirection can be performed by mechanical steering of the deflection optics, or by non-mechanical means such as acousto-optical or electro-optical deflection.

In a preferred embodiment of the present invention, the optical-deflector is a flat mirror mechanically mounted to enable controlled 2-D angular steering. This embodiment involves no active or complex optical components and offers the advantage of simplicity and high throughput efficiency. The optical-deflector in this embodiment changes the direction, but not the angular spread (i.e., divergence) of the optical beam.

There are many alternate embodiments of the optical beam-deflector that provide essentially the same functionality for the purposes of the present invention. Optically passive beam redirection can be achieved by various optical elements (such as reflectors, refractors, or gratings) used either singularly or in various combinations. Such elements may be composed of many different materials and formed into many different shapes. The design of these optical elements can be used to change the angular spreading of the output beam, either focusing or diverging it. The elements can also be designed to provide some passive signal selectivity by such means as wavelength or polarization filtering.

From FIGS. 1-6, it should be apparent that optical signals are transmitted from the transmitter of the master unit 30 in the master station 12 through one or more beam deflector units 40 in relay stations 14, to respective client units 16 via beam paths 18. Similarly, optical signals generated by the transmitter included in the client unit 16 are transmitted via the beam paths 18 and beam deflector units 40 in relay stations 14 to the respective master units 30 in the master station 12. Because the beam paths 18 are free-space beam paths, installation does not require the routing of optical fiber between the master station 12 and the client unit 16. The system 10 can be used to provide cost-effective, high-bandwidth, optical data transmission bi-directionally between the master station 12 and client units 16. For example, the optical system 10 can be used to provide high-bandwidth Internet access to the client units 16. The following sections will provide further information regarding examples of selected components of the master units 30, the beam-deflectors 40 and the client units 16 described above, and will then turn to a preferred, automated method for aligning the optical components of the communication system 10.

Optical Source

In a preferred embodiment of the present invention, the electromagnetic radiation for the optical sources 52, 72 is produced by solid-state laser diodes operating at near-IR wavelengths (i.e., 0.7<λ<2.5 micrometers). This embodiment has the advantage of a compact, efficient, conveniently modulated light-source with a human-invisible (hence unobtrusive and esthetically inoffensive) wavelength. It is apparent, however, that a wide variety of other light-sources and optical wavelengths can be used. Such light-sources may involve (for a non-exclusive listing) incoherent but modulatable sources such as florescent lamps, as well as light-emitting diodes, other types of lasers, etc. Any wavelength for which the atmosphere is sufficiently transparent can be used; for instance the present invention can be implemented with other human-invisible wavelengths in the UV or IR portions of the spectrum, or it can utilize more obtrusive wavelengths in the visible portion of the spectrum.

In a preferred embodiment of the present invention, the electromagnetic radiation transmitted by the optical source 52, 72 forms an angularly-confined beam, designed to fill (but not greatly overfill) the aperture of its target (one or more optical receivers or optical beam-deflectors at the appropriate level-1 relay-station). This embodiment has the advantage of being energy-efficient, not wasting large amounts of photons that will never be delivered to optical-receivers. In this embodiment, some or all of the opticalsource's angular-confinement may be intrinsic in the light-source itself, or some or all of the confinement may be enforced by an optical beam-director (e.g., a lens or a focusing reflector). In this embodiment, means are provided to aim the transmitted beam at its target (either a level-1 optical beam-deflector or an optical receiver). This aiming may be provided by human-pointing of each optical beam-director. A preferred embodiment, however, utilizes fully-automated pointing of the optical beam-directors after physical installation of the master unit, i.e., means involving no ad hoc human participation.

An alternate embodiment of the present invention utilizes un-aimed, broad-angle light-sources (such as lamps or LEDs). If the optical circuit contains no optical beam-deflectors, then the signal remains a broad-angle beam until its arrival at the client unit, but if optical beam-deflectors are present, they effectively form narrow-angle signal beams. This embodiment has the advantage of simplicity, but the drawback of energy inefficiency, as only a small fraction of transmitted photons eventually arrive at the client unit.

Optical Receiver

The optical receivers of the master units 30 and the client units 16 serve to intercept an incident optical beam, and to extract the communication signal from the beam.

The optical radiation incident upon each receiver is angularly-limited due to the finite solid-angle subtended by its previous departure point (either the optical source's beam-director or an intermediate optical beam-deflector). While the incident signal beam is angularly confined, it generally arrives with a cross-sectional area considerably larger than typical photodetectors (i.e., semiconductor photodetectors).

In a preferred embodiment of the present invention, these two circumstances lead to an optical receiver that contains the steering system 62, 82 and the beam director 50, 70 that acquire the incident beam and spatially concentrate it onto a smaller aperture semiconductor photodetector. The optical concentrator in this preferred embodiment includes an opaque tube with a lens at one end and a smaller-aperture photodetector at the other (the distance separating the two elements being determined by the focal length of the concentrating lens). The advantage of a semiconductor photodetector in this embodiment is that such devices are inexpensively available and readily operated, are responsive to high-bandwidth signals, and provide an electrical signal from which the communication signal can be conveniently extracted. The use of an optical-concentrator in this embodiment offers several advantages. As the input aperture of the optical-concentrator is typically much larger than that of the photodetector, the concentrator effectively increases the capture area of the photodetector, allowing it to acquire more signal photons. Another advantage of the optical-concentrator is that it is angularly-selective, responding most effectively to incoming signals with a relatively narrow and specifically-oriented angular distribution. This feature is useful in reducing the number of solar photons that enter the photodetector and, in daylight conditions, contribute ‘clutter’ to the communication process. The use of a single lens as the optical concentration element in this embodiment is advantageous due to its simplicity and inexpensive implementation. Use of a directional optical-concentrator does require that the optical-concentrator must be accurately aligned with the incident signal beam, which is incoming either directly from the optical source's beam-director, or from an optical beam-deflector in the communication circuit. As described above, this invention, this controlled alignment can be provided by attaching the optical-concentrator to a mechanically steerable mount, or by using a beam deflector as described below.

There are many alternate embodiments of the optical-receiver that provide similar functionality for the purposes of the present invention. Many different optical concentrator designs are possible; it is feasible to use reflectors or diffractive optics instead of a refractive lens, to use multiple such elements or combinations of such elements. The photodetector need not be placed at the primary focus of the concentrator; one can interpose relay optics, optical fibers, or other elements between the concentrator and the photodetector. It is possible to incorporate optical devices, e.g., wavelength- or polarization-filters, before the photodetector to aid in signal enhancement or clutter rejection. There are many different types of photodetectors that can be used instead of semiconductor-based ones; these include devices such as photomultiplier tubes, vacuum diodes, photoconductors, etc.

It is also possible to implement the optical-receiver without use of an optical-concentrator. One can adopt a design without area concentration, while retaining directionality; such a design is typified by a “soda-straw” placed between the incoming beam and the photodetector. While this approach does not achieve area-enhancement of the signal, it does angularly discriminate against ambient optical, e.g., solar, clutter; as with directional optical-concentrators, this device must be pointed towards the incoming light beam. Another, simpler approach is to use a bare, mechanically-fixed, wide-angle photodetector. This embodiment has the advantage of requiring no mechanical pointing mechanism; there are practical circumstances (e.g., nighttime operation) where its inferior noise rejection is acceptable.

Optical Transceiver

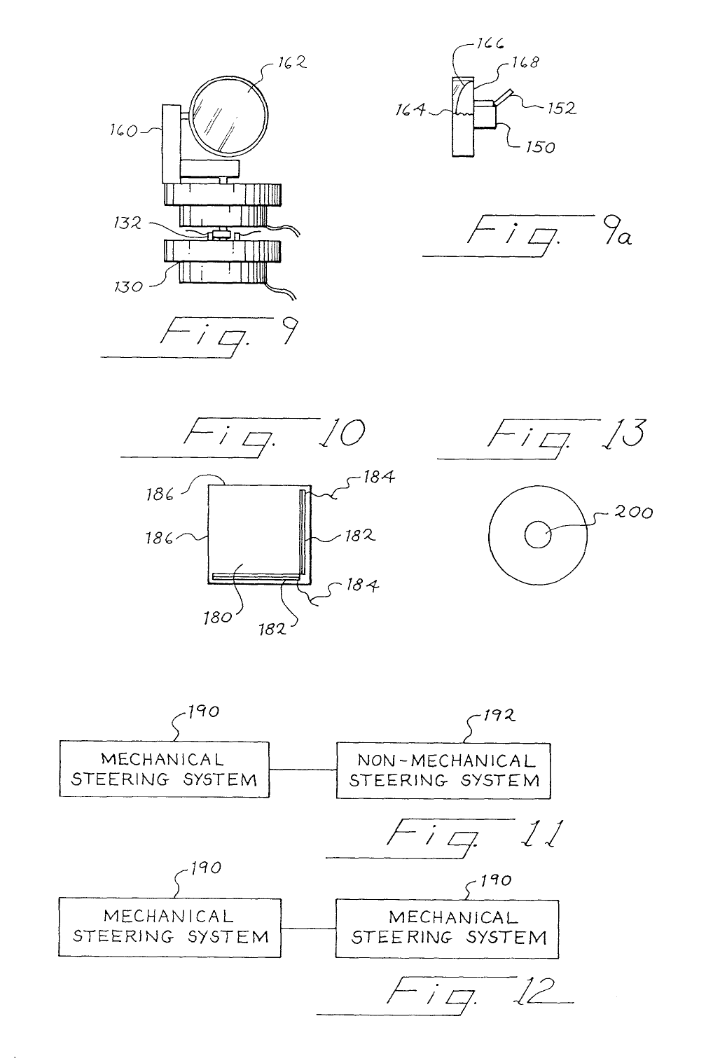

An in-the-field example of an optical transceiver suitable for use in each master unit 30 and each client unit 16 is shown in FIG. 7. This transceiver includes a multilayer, dielectric, spectral bandpass filter 100 positioned immediately in front of a primary converging lens 102. The primary converging lens 102 focuses incoming light along a beam axis aligned with the axis of the optical transceiver through a precision pinhole 104 to a secondary converging lens 106, and then to a beam splitter 108. Incoming optical signals accepted by the optical system made up of elements 100-106 are focused by the lens 106 onto a photodetector, which may correspond to the photodetector 56 of FIG. 4 or the photodetector 76 of FIG. 5. For example, the photodetector 56, 76 may be a fast photodiode and an associated preamplifier that function as an optical signal detector.

The transceiver of FIG. 7 also includes an optical source such as a laser diode that corresponds to the optical source 52 of FIG. 4 or the optical source 72 of FIG. 5. Light from the optical source 52, 72 passes through a beam divergence equalization lens 110, and is then reflected by the beam splitter 108 to the secondary converging lens 106, the pinhole 104, the primary converging lens 102 and the bandpass filter 100. The equalization lens 110 converts the fundamentally rectangular beam profile generated by a laser diode into a roughly circular form. Such an equalization lens 110 will not be required for all embodiments.

The beam splitter 108 shares the transceiver's optical paths defined by the coaxial lenses 102, 106 between the transmitter function implemented by the optical source 52, 72 and equalization lens 110 and the receiver function implemented by the photodetector 56, 76. In addition to economizing on total parts count, such sharing automatically assures the coaxiality of the transmitted and received optical signal beams.

In this example, the primary converging lens 102 is circular in cross section, and a corner cube retro-reflector 114 is positioned in alignment with the central axis of the lens 102. The retro-reflector 114 can selectively be covered or masked by a cover 116 (when the cover 116 is positioned to obstruct the retro-reflector 114) and exposed in the direction of the optical beam (when the cover 116 is moved away from the retro-reflector 114). The position of the cover 116 is controlled by an actuator 112 such as a solenoid.

The transceiver of FIG. 7 is well suited for bi-directional communication along the beam paths described above. Of course, in an alternative embodiment the transceiver of FIG. 7 can be simplified to perform only optical transmitter functions or only optical receiver functions by eliminating components that are unnecessary for the selected function.

The spectral filter 100 is preferably positioned transverse to the optical axis of the transceiver. Optical radiation coming from off-axis directions is focused by the lens 102 onto a non-central (and therefore opaque) portion of the pinhole 104, and is therefore rejected from the optical train defined by the coaxial lenses 102, 106 and the precision pinhole 104. Thus, incoming optical radiation is spatially filtered by the joint action of the lenses 102, 106 acting in concert with the precision pinhole 104. In this particular example, the relative position of the elements 102, 104, 106 should be maintained at the design values to ensure optimal performance. Mis-positioning of either lens 102, 106 relative to the pinhole 104 results in roughly quadratically severe optical transfer efficiency losses. When operated with a clear aperture that is not large as compared to the diffraction limited spot size of the focusing lens 102, this spatial filtering operation also generates a clean transmitted beam, i.e. one in which beam divergence may be limited only by the intrinsic qualities of the lenses 102, 106.

In one example, the optical beams generated by the optical source 52, 72 are characterized by a free-space wavelength λ that is less than 10 micrometers. The spatial and spectral filtering of the optical beam directors 50, 70 are preferably selected to more effectively reject ‘clutter’ from the Sun and possibly of anthropogenic origin that acts to obscure the incoming signal, and to allow the optical beam to be detected in the presence of sunlight. The spatial filter serves to reject light from all spatial origins except for a small angular width about the incoming beam (which is aligned with the axis of the receiver), and the spectral filter similarly serves to reject light from all portions of the spectrum except for that band of frequencies (typically, narrowly) centered on the frequency of the signaling beam. The use of a combination of spectral and spatial filters offers concatenated rejection-action against clutter, and thus is especially powerful.

The pass band of the filter 100 is preferably greater than 0.5 nanometers and less than 10 nanometers in width, and the spatial acceptance angle Δθ is preferably greater than 0.03 millirad and less than 1 millirad. The values of Δλ and Δθ are preferably chosen such that Δλ·Δθ² is less than about 10⁻⁴ nanometers·rad². This combination increases the signal-to-noise ratio of the accepted optical signal, even in the presence of direct sun light and its associated noise, allowing, in one example, the optical source 52, 72 to be a relatively low-power device, such as a 5 milliwatt laser diode.

As explained in greater detail below, the retro-reflector 114, the opaque cover 116, and the actuator 112 can be used to signal, reversibly and passively, the spatial location of the input aperture of the transceiver of FIG. 7. When the cover 116 is removed from the front surface of the retro-reflector 114 by action of the actuator 112, optical radiation aligned within the (virtually panchromatic) spectral bandwidth of the retro-reflector that is incident upon the retro-reflector's front surface for nearly all of the 2π solid angle forward of the retro-reflector-and centered on the normal to its face is retro-reflected to its source, thereby signaling that an optical search beam has impinged upon this front surface. When the cover 116 is moved to obscure the front surface of the retro-reflector 114, any such incident search beam is not reflected, and the retro-reflector 114 (and the associated transmitter, receiver or transceiver) is effectively hidden from the source of the search beam. This reversible retro-reflection feature is not required for a proper functioning of the transceiver (or the transmitter or receiver that may replace the transceiver), but is used as described below for alignment acquisition. The retro-reflector 114 is preferably positioned in the center of the aperture of the lens 102.

The example of FIG. 7 demonstrates one of many possible ways to implement the beam generation/reception functions of the transceiver. One alternative embodiment simplifies the above design by combining lens 106 and the beam-splitter 108 into a single beam-splitting/focusing element. This element focuses light from the pinhole directly onto both the laser diode and the photodetector. The pinhole-to-laser diode focusing is achieved reflectively by making the front surface of the element an off-axis portion of an ellipsoid, having the pinhole at one focus and the laser diode at the other focus. The pinhole-to-photodetector focusing is achieved refractively by making the bulk of the element (after the semi-reflective, beam-splitting, front surface) a focusing lens, having the pinhole at one conjugate and the photodetector at the other conjugate.

As explained above, it is generally preferred to be able to angularly orient (i.e., steer) the optical transceiver. This orientation serves both to efficiently direct the transmitted signal towards its target (either an optical receiver or an optical beam-deflector), and to acquire and concentrate onto the photodetector only those optical signals from the proper optical circuit. Because of optical reciprocity, these outgoing and incoming directions are preferably co-aligned; this can be insured by appropriate design of the transceiver's optical components. It is also preferable to provide the transceiver with a steering system so as to control the common angular direction of the incoming and outgoing beams.

In a preferred embodiment of the present invention, optical steering is provided though mechanical, optically passive, means. A number of techniques can be used for this task. One approach is to mount the entire transceiver upon a mechanically pointable platform that can be steered through two degrees of angular freedom. Another approach is to utilize a mechanically fixed transceiver, but to intercept (on the free-space side of the transceiver) the beams with a steerable beam-deflector such as one of those described in connection with FIGS. 8-12. In a preferred embodiment of the present invention, the steerable beam-deflection is provided by a flat turning mirror, mechanically mounted so as to be steerable through two degrees of angular freedom. A number of alternative mechanical beam-deflectors are also possible. One can use two or more separate beam deflectors, each of which is steerable through one degree of angular freedom. One can use more complex passive optical deflector elements (such as reflectors, refractors, or gratings) used either singularly or in various combinations. Such elements may be composed of many different materials and formed into many different shapes. It is also possible to combine these two steering techniques, mechanically mounting the transceiver in a manner permitting one degree of angular motion, and delivering additional angular steering via a one degree of freedom beam-deflector.

In another embodiment of the present invention, beam steering can be achieved by non-mechanical, optically active, means, using techniques such as acousto-optical or electro-optical deflection. While these methods may not offer either the technological simplicity or range of motion of optically passive, mechanical steering systems, they can provide advantages such as steering-speed and lack of moving parts. As with mechanical systems, the desired two degrees of angular steering can be delivered either directly by a single device or by multiple one-degree-of-deflection devices. One can also combine mechanical and optically-active steering systems, using each to deliver part of the angular steering.

Beam-Deflector

The beam-deflector unit 40 of FIG. 6 may be implemented in many possible ways to accomplish the basic purpose of relaying an optical beam incoming from an angular direction characterized by two Euler angles [θ,φ] into a beam outgoing into an angular direction [θ′, φ′], where the normal to the reflecting surface of the passive element 90 (in the case where the beam-deflector 40 includes a flat mirror as the passive element 90) bisects the angle formed by the axis of the incoming and outgoing beams. FIGS. 8, 9 and 10 illustrate three possible implementations. Many different but functionally equivalent implementations will be apparent to one ordinarily skilled in the art.

The beam-deflector of FIG. 8 includes a low-rate motor and gear box 130 having an output shaft that supports a high-rate motor and gear box 134. The angular position of the output shaft of the motor and gear box 130 is sensed by cam-actuated shaft angle sensing switches 132.

The high-rate motor and gear box 134 includes an output shaft that supports a rotary cam 136 that is formed of a ferromagnetic material, and an actuating rod 138 is supported for sliding motion along the axis of the rod 138 by a mount 142 that is secured to and rotates with the body of the motor and gear box 134. Thus, the rotational position of the mount 142 is determined by the rotary movement of the output shaft of the motor and gear box 130.

The mount 142 also supports a hinge 144 that in turn supports a front surface reflecting flat mirror 148 mounted on a ferromagnetic back plate 146. The mirror 148 corresponds in this example to the optically passive element 90 of FIG. 6, and the elements 130-144 correspond to the steering system 92 of FIG. 6.

The mirror 148 also supports a retro-reflector 150 having a front surface that can be covered or revealed by a movable opaque cover 152, the position of which is controlled by an actuator 154. The retro-reflector 150 and associated components perform similar functions to those described above in conjunction with the retro-reflector 114 of FIG. 7.

In the example of FIG. 8, the flat mirror 148 may be panned and tilted by entirely mechanical means in order to sweep out each of the two independent angles. Azimuthal angle sweeping is performed by actuating the low-rate motor and gear box 130 to rotate the entire assembly above the motor and gear box 130 about the axis defined by the output shaft of the motor's integrated gear box. This shaft mounts one or more cams that actuate the shaft angle sensing switches 132 that inform the control system as to when predetermined shaft angle limits have been attained.

The high-rate motor and gear box 134 generates the other Euler angle of flat reflector motion, that of elevation. In this non-exclusive example, elevation is swept repetitively and rapidly as the rotary cam 136 rotates, while azimuth is swept slowly. A single increment in azimuth motion occurs while an entire motion cycle is performed in elevation motion. In this example, the high angular rate shaft motion of the upper motor and gear box 134 is converted to elevation motion of the mirror 148 by the cam 136, the rod 138, and the hinge 144. The rod 138 is provided with a magnet at each end, and these magnets hold the rod 138 in constant sliding contact with both the cam 136 below and the ferromagnetic back plate 146 above. The bearing 140 confines the rod 138 to vertical motion in the view of FIG. 8. As the cam 136 rotates, the rod 138 oscillates in the bearing 140, and thereby drives the mirror 148 through an oscillatory waving motion about hinge 144. In this way, the vertical component of the motion of the upper surface of the cam 136 immediately below the rod 138 is imposed upon the mirror 148, thereby causing it to sweep in elevation about the hinge 144.

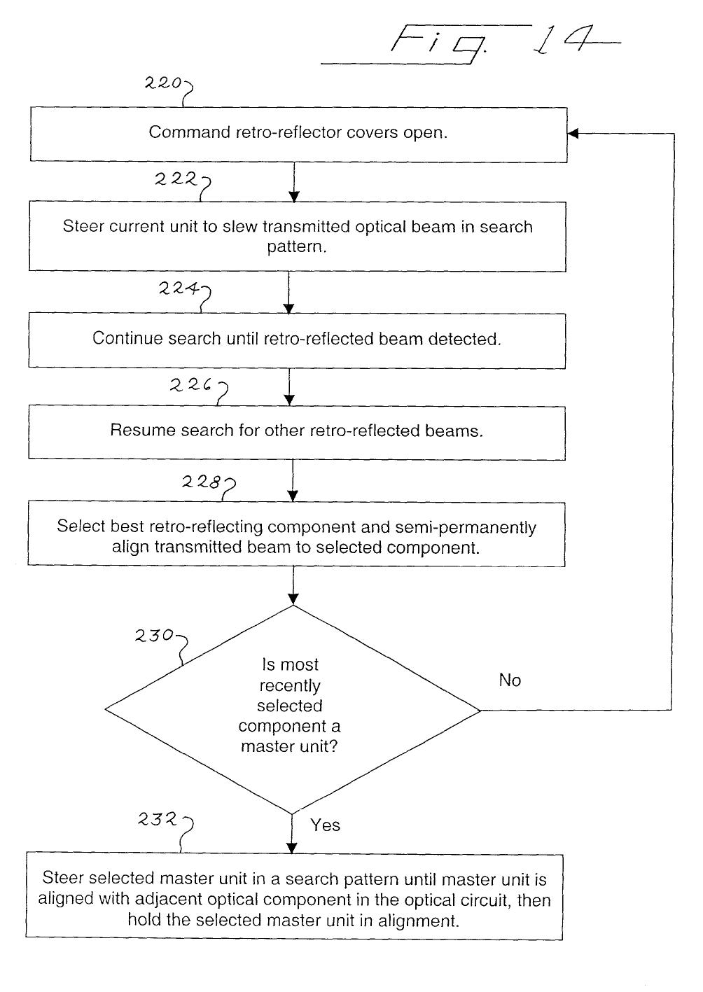

FIG. 9 shows another beam-deflector that includes a motor and gear box 130 and cam operated switches 132 similar to those described above. A first electric motor 130 is mounted to a fixed support with its rotating shaft aligned vertically. A second electric motor 160 is attached to the rotating shaft of the first motor, and is aligned so that its rotating shaft is horizontal, perpendicular to that of the first motor 130. A beam-deflecting element 162 is attached to the rotating shaft of the second motor 160, and that motor is positioned so that the center of the element 162 is located in-line with the rotating vertical shaft of the first motor 130. This particular mounting technique permits (by appropriate activation of the two electric motors) the mirror to be rotated through two orthogonal degrees-of-freedom, without changing its centroid location. Accordingly the location of the beam-deflector does not change (preserving alignment with other elements in the communication-channel) as the beam deflector controllably deflects an incident light beam through large, mutually-orthogonal, angles. In this preferred embodiment of the present invention, the electric motors are step motors, actuated though discrete angular steps. When the desired alignment of the beam-deflector is reached, the step motors are no longer actuated, and the pointing mechanism thereafter remains in the selected position.

FIG. 9a shows a side view of the beam-deflecting element 162 in partial cutaway. This element 162 includes a double-sided flat mirror having a flat reflecting surface 164 on one side and a concave lens 166 on the other. A mounting strut 168 extends across the concave lens 166 and mounts a retro-reflector 150, cover 152 and actuator 154 similar to those described above. By choosing which of the two elements 164, 166 to present to the incoming beam, the control system can thereby choose whether or not optical power is inserted into the beam-deflection process. In the example of FIGS. 9 and 9a, beam-deflection is performed by either the flat surface 164 or the concave lens 166 having a circularly symmetric, positive (beam-diverging) optical power, depending upon which of the two sides of the beam-deflection element is presented to the incoming beam. In this embodiment, the flat reflecting surface 164 is used during data transmission and some alignment searches, and the concave lens 166 is used for other alignment searches conducted at a coarser level of resolution. The concave lens 166 is initially presented outward so as to expose the retro-reflector 150 with open cover 152 to other seeking beams of the system. The flat surface 164 can be used after initial coarse acquisition to present a flat beam-deflecting element with zero optical power.

The beam-deflecting element 162 is an example of an optical element that in one orientation can be used to converge or diverge the outgoing (deflected) beam as compared to the incoming beam, in either one or both of the beam-transverse directions (possibly by different amounts in the two beam-transverse directions), and in the other orientation to make no change. As described below, during initial alignment of the optical circuit, it may be desirable to exhaustive search with a relatively wide-angle beam so as to minimize the total search time, and then to search with a relatively narrow angle beam for final alignment. The ability to insert, albeit only temporarily, an optical element to effect this greater beam divergence during initial alignment operations can be of considerable utility. Many alternatives to the concave lens backed by a flat mirror may be used; options include convex mirrors, diffractive elements, etc.

FIG. 10 shows yet another type of beam-deflector that can be used in implementing the beam-deflector 40. The beam-deflector of FIG. 10 includes a dual-axis surface acoustic wave (SAW) plate 180 that is presented to the incident beam. PZT SAW launchers 182 launch surface acoustic waves across the plate 180, under the control of signals applied via drivelines 184. Acoustically absorbing edge coatings 186 are applied to the opposite edges of the plate 180. The surface acoustic waves generated on the plate 180 by the launchers 182 deflect the incident beam through two axes of angular deflection. The piezoelectric transducer launchers 182 are excited by periodic electrical signals applied via the drivelines 184. The resulting surface acoustic waves Bragg-diffract the incident light beam into the particular outgoing direction determined by the two frequencies at which the two launchers 182 are excited. Wave energy reaching the far edge of the deflecting plate 180 is absorbed, for example by the edge coating 186. Thus, the deflector of FIG. 10 accomplishes the desired two-axis beam-deflection in a non-mechanical manner using acousto-optical effects. This type of deflection is particularly useful when deflection through relatively small angles and with high agility is sought. As such, it may be usefully compounded with relatively coarse mechanical beam-deflection through large angles, with a surface acoustic wave plate 180 used in place of the mirror 148 of FIG. 8 (and with the retro-reflector 150 levitated slightly above its surface with fine struts, so as not to interfere with SAW propagation).

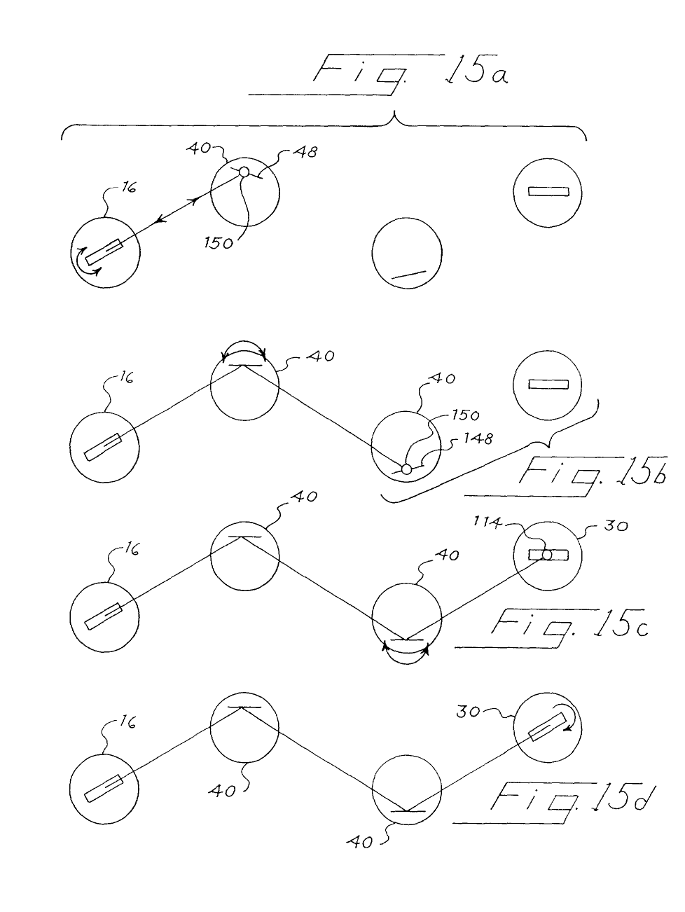

FIG. 11 shows another type of beam-deflector that combines a mechanical steering system 190 with a non-mechanical steering system 192. The mechanical steering system 190 can be of the type described above and provides beam-deflection through one of two independent angles by mechanical motion. The non-mechanical steering system 192 can for example be a SAW deflector as described above or an electro-optical deflector, and it steers the incoming beam through another angle of deflection by non-mechanical means. For example, the mechanical steering system 190 can include the motor 130, and the non-mechanical steering system 192 can include a single axis PZT SAW plate. In this example azimuthal scanning is performed by the mechanical steering system 190, and elevational scanning is performed by the non-mechanical steering system 192 by varying the frequency used to excite the SAW-launcher element (which may, for example, be positioned where the hinge 105 is positioned in FIG. 8). As before, the retro-reflector 150 should be acoustically decoupled from the surface acoustic wave plate.

FIG. 12 shows another alternative version in which two separate mechanical steering systems 190 are provided, each with its own respective reflector, and each operating to steer the incoming optical beam over a respective angle.

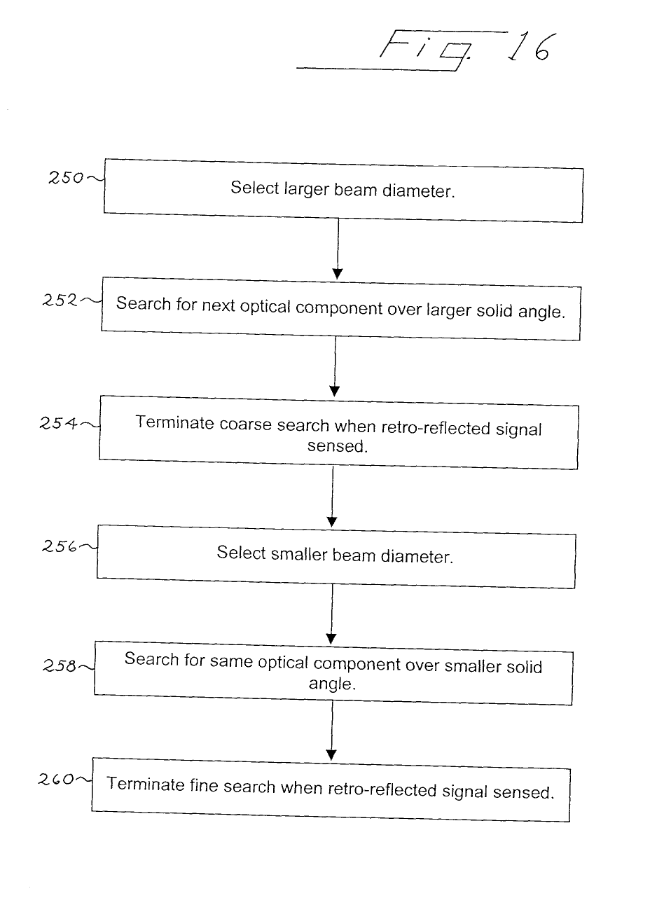

In an alternative, the alignment acquisition function performed by the retro-reflectors described above can alternatively be performed by substituting a wide-angle photodetector for the switchable retro-reflectors described above. Such a wide-angle photodetector is shown in FIG. 13 by way of example as a photodiode 200 centered in the receiving aperture of the beam-deflector. Also, the retro-reflectors and/or the wide-angle photodetectors described above can be used on the master units 30 or the client units 16 as appropriate.

In order to assist in acquisition during alignment, the retro-reflectors 114, 150 and the wide-angle photodetectors 200 preferably have an acceptance angle greater than 0.03, more preferably greater than 0.3, and most preferably greater than 3 steradians.

The various steering systems described above for the master units 30, the beam-deflectors 40, and the client units 16 preferably steer the respective optical beams over a solid angle greater than 0.03, more preferably over a solid angle greater than 0.3, and most preferably over a solid angle greater than 3 steradians.

Alignment Method

The system 10 provides for adequately accurate alignment of the optical elements used to implement each communication circuit. The master unit 30 is generally pointed towards the first-level optical beam-deflector 40; each optical beam-deflector 40 is pointed properly to redirect the incoming light-beam onwards to the next element in the circuit, and the client unit 16 is generally pointed towards the final optical deflector in the circuit to within its angular acceptance. All of these elements include accurate means of being controllably pointed, and are directed so as to point correctly, to within tolerable imprecision.

The communication circuits described herein are semi-permanent ones, intended to maintain links between a master and a client for long intervals of time. In a preferred embodiment of the present invention, each such circuit is setup and aligned just once. Accordingly, the pointing mechanisms are only required to perform a few (in the limit, only one) steering operations during their operational lifetimes; the pointing techniques and components can be chosen to take advantage of this limited use. Another consequence of establishing semi-permanent communication circuits is that it is not necessary that they be rapidly established; in particular, the pointing mechanisms do not have to be designed for rapid steering capability.

The alignment of an optical circuit requires that each of its components be properly oriented. We prefer a pointing procedure that is automatic, not one which is human-intensive, to perform automatic circuit alignment in the absence of a-priori knowledge of the 3-D locations of the circuit components. In the absence of accurate, a-priori, pointing knowledge, each component has very many more incorrect pointing directions than correct orientations; a typical ratio being ˜10⁸. Since our optical circuits often involve at least 3 pointable components (master, beam-deflector, and client), the circuit features 10²⁴ more improper orientations than proper ones. Since an exhaustive search for the correct set of component orientations would be extremely challenging, a preferred embodiment of the present invention performs the alignment by sequentially pointing the components, one at a time; for the previous example, this technique cuts the search space from 10²⁴ down to 3×10⁸.

A non-exclusive, in-the-field example of such an automatic directional control process is provided for a communication circuit, containing a master unit, one or more optical beam-deflectors, and a client unit. In addition to their primary optical communications elements, these circuit units are also provided with extra components to aid in the alignment process. One such component is an impact detector, whose role is to allow the system to know when it has been successfully pointed at by a neighboring unit. In the current example, this task is performed by the wide-angle, on-off switchable, retro-reflector described above; but alternative components, such as a wide-angle photodetector described above, can also perform the same function. Another alignment aid is a low data-rate communication system, used to provide basic coordination services during the alignment process. In the current example, this task is performed by a short-range RF broadcast system, but alternative approaches can also perform the same function.

The optical system 10 of FIG. 1 is preferably automatically and sequentially aligned without human assistance, and without advance knowledge of the positions of the optical components of the system. Each of the master units 30 and the beam-deflectors 40 is provided with a respective impact detector, e.g., a retro-reflector or wide-angle photodetector as described above, and the respective steering systems are controlled automatically to achieve the desired alignment. FIG. 14 provides a flow chart of one example. In this example, automatic alignment commences with the client unit of the circuit. Typically, this is the last element to be installed in the circuit. When transceivers are used for circuit implementation, automatic alignment can be performed starting at either the master unit or the client unit end of the optical circuit.

In the example of FIG. 14, a client unit 16 broadcasts a command in block 220 with an auxiliary low-power, low-bandwidth, limited-range RF transmitter. This command requests all master units and beam deflectors that are not already committed to another, pre-existing optical circuit to activate their impact detector (in this example, to uncover their respective retro-reflectors). Then, in block 222, the client unit steers its transmitted optical beam in a search pattern that extends over a large solid angle, e.g., 2π. The client unit 16 interrupts the search in block 224 when a retro-reflected beam from one of the exposed retro-reflectors is detected at the client unit. The wide-angle retroreflectors serve as impact detectors by reflecting light back to the client unit, where it is received by the transceiver's narrow acceptance-angle photodetector (co-aligned with the outgoing signal from its beam director). Receipt of such a back-directed return signal indicates that the client unit has been properly pointed to another unit of the optical system. Knowledge as to which unit has been reached can be provided in a number of ways; one approach is to vibrationally modulate the retroreflector so as to ID tag the reflected beam, another is for the client to command (via the RF link) all the reachable units to switch-off their retroreflectors one-at-a-time until loss-of-return denotes which unit has been reached.

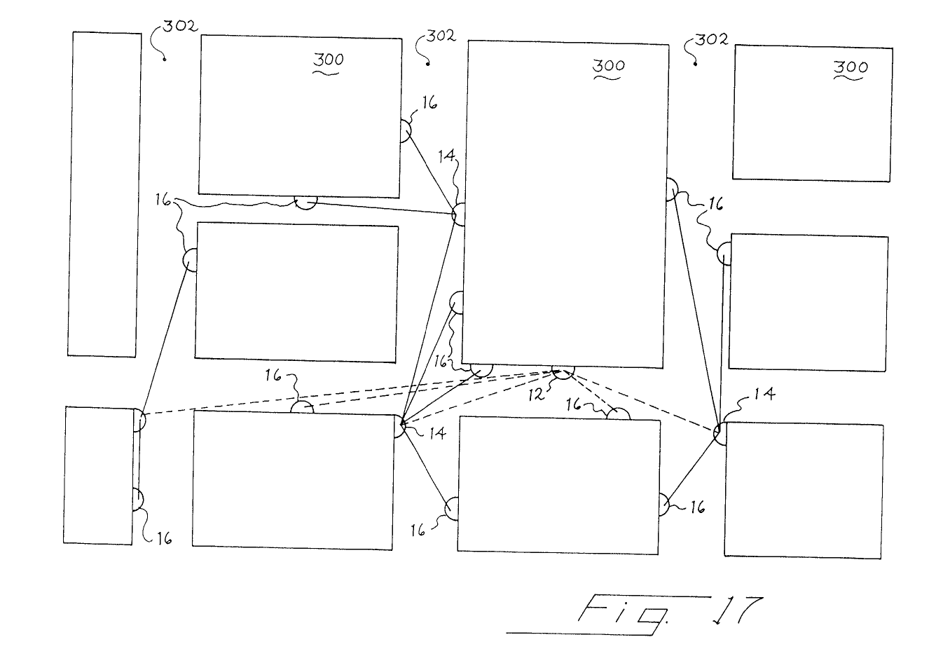

The solid angle coordinates of this retro-reflector are recorded, and the search is then continued in block 226 for other retro-reflected beams within the field of regard of the client unit. The client unit then makes a selection in block 228 among the components that return a retro-reflected signal (generally selecting one associated with a master unit if one such is available, and otherwise selecting a beam-deflector most proximate to a master unit, if this information is available). The client unit then locks in position to hold the client unit in alignment with the selected retro-reflector and notifies the associated optical component via the auxiliary signal system. This selected component (master unit or beam-deflector) is thereafter assigned to the selecting client unit. This completes phase I of the automatic alignment procedure, as illustrated in FIG. 15a.

Then the client unit determines in block 230 whether the most recently selected component is an optical receiver (i.e. a master unit). If not, blocks 220-230 are repeated, in this case steering the most recently selected beam-deflector. Specifically, in phase 11 the most recently selected beam-deflector signals with the auxiliary signaling system for all uncommitted beam-deflectors and master units in its vicinity to uncover their respective retro-reflectors. The most recently selected beam-deflector then exhaustively searches the available solid angle until it receives a return from one of these uncovered retro-reflectors, using the optical beam already aimed at it by the client unit 16. The beam-deflector then repeats the process described above for selecting a beam-deflector or a master unit from among those systems that are optically accessible to it. This selected component is then committed to this optical circuit (FIG. 5b). When block 230 of FIG. 14 is again executed, the most recently selected component of the nascent optical circuit may or may not be a master unit. If not, blocks 220-230 are again executed, thereby aligning a second beam-deflector, as shown in FIG. 15c.

This process continues until the most recently selected component tested in block 230 is a master unit. In this case, control is transferred to block 232, and the selected master unit proceeds to align itself with the nascent optical circuit by exhaustively searching the available solid angle. The alignment can be achieved either by using the beam from the client unit and steering the master unit until its signal reception photodetector is properly aligned with the nascent optical circuit, or by using an optical beam from the master unit and steering the master unit until this beam is propagated back through the nascent optical circuit and it is acquired by the signal reception photodetector of the client unit. Once the master unit has been aligned in this fashion, it stops further searching, and the automatic alignment of the optical communication circuit has been completed. This is accomplished automatically, without human participation or intervention, and without advance knowledge of the location of the various optical components.

The example of FIG. 14 was based on the embodiments described above including retro-reflectors as impact detectors. The same basic automatic alignment method functions can be performed using a wide-angle photodetector rather than a retro-reflector to detect when a searching beam is aligned with a next optical component in the optical circuit. The auxiliary signaling system is used to communicate to the searching component that the optical beam has impacted the wide-angle photodetector.

The search used in the method of FIG. 14 such as the search of block 222, 224 can be conducted as a single stage search in which an optical beam is sequentially directed in any desired sequence of directions over the available solid angle. Similarly, in block 232 a receiver can be steered in a single-phase search pattern. Alternatively, such searches can be conducted in two or more phases, using a successively-narrowed beam in each phase relative to that employed in the previous phase, so that the desired pointing is attained with ever-greater accuracy in each phase of searching.

Typically, the search pattern of block 222 or 232 will use a successively-narrowed beam in each phase relative to that employed in the previous phase, so that the desired pointing is attained with ever-greater accuracy in each phase of searching. The initial phase of searching will typically be over a solid angle of at least 0.03 steradian.

For example, as shown in FIG. 16, a search can be conducted by first selecting a relatively large beam diameter (block 250), and then searching for the next optical component in the optical circuit over a larger solid angle (block 252). This coarse search is terminated when the retro-reflectored signal is sensed (block 254). Then a relatively small beam diameter is selected (block 256) and a second search is conducted in block 258 for the same optical component over a smaller solid angle than that used in block 252. This fine search is then terminated in block 260 when the retro-reflected signal is acquired. Optical elements similar to the beam-deflecting element 162 described above can be used to select the larger optical beam diameter of block 250 or the smaller optical beam diameter of block 256.

This automatic alignment technique has the advantage that the physical locations of the elements (optical-source, optical beam-deflector, optical-receiver) do not have to be known, and it exploits the fact that the communication circuit does not have to be established rapidly (e.g., on sub-second time-scales).

This automatic alignment procedure can be used to establish optical circuits containing either a single optical beam-deflector, multiple beam-deflectors, or no beam-deflectors. While the example presented above was for a preferred embodiment of the present invention in which all of the circuit units delivered directional beams and hence had to be actively pointed to their neighbors, the automatic alignment procedure can also be used if some of the circuit units are wide-angle, unpointed units. The order-of-alignment can also be changed, proceeding from the master unit to the client unit; such an arrangement is necessary for uni-directional circuits. In this case, of course, the final client alignment is performed by steering its receiver, rather than reverse transmitting a beam back along the circuit.

The method described above renders effectively transparent to the signaling radiation even very complex and optically dense environments, such as central urban areas comprised of “canyons of concrete.” Its automatic establishment of sometimes highly complex optical paths permits low marginal cost creation of high-bandwidth optical communications links of substantial length and arbitrary three-dimensional geometry.

FIG. 17 provides an example of how the system 10 described above can be used in an urban setting. In FIG. 17, the shaded rectangles indicate buildings 300, and the buildings 300 are separated by streets 302. As shown in FIG. 17, a master station 12 is mounted on the side of a first building, and various relay stations 14 and client units 16 are mounted on respective building walls. Note that this nonlimiting example (which is not drawn to scale) includes a single master station 12, four relay stations 14, and 12 client units 16. Two examples are shown of optical circuits in which a master unit in the master station 12 connects directly to a client unit 16. Eight examples are shown where a master unit included in the master station 12 is connected by a single relay station 14 to a respective client unit 16. Two examples are shown where a client unit 16 is connected to a respective master unit in the master station 12 by an optical circuit that includes two separate relay stations 14.

From FIG. 17 it should be apparent that the optical communication system described above is well suited for applications in which homes or businesses are provided with high-bandwidth optical data communication in a reasonably dense urban-industrial environment. For example, master stations can be spaced at center-to-center distances on the order of one kilometer, with each master station serving to interconnect many downstream client units to the global digital network, e.g. the Internet. Each master station can be interfaced directly to the global digital network, or alternatively one master station can connect to the network via another master station. High data transfer rates (e.g., greater than 10⁶ bits per second) can be achieved.

It should be apparent from the foregoing detailed description that many changes and modifications can be made to the preferred embodiments described above. For this reason, this detailed description is intended by way of illustration, and not by way of limitation. It is only the following claims, including all equivalents, that are intended to define the scope of this invention.

1. An optical communications system comprising at least one optical circuit, each optical circuit comprising:
a set of at least one downstream client unit, each client unit comprising:
an optical receiver which accepts an incoming optical signal;
a photodetector associated with the respective optical receiver and responsive to electromagnetic radiation accepted by it;
a demodulator associated with the respective photodetector;
a set of at least one upstream master unit, each master unit semi-permanently optically coupled to the respective client unit, each master unit comprising:
an optical source operative to generate an optical signal characterized by a free-space wavelength less than about 10 micrometers;
a modulator operative to modulate the respective optical signal;
an optical beam director associated with the respective optical source and operating to direct the respective optical signal into free-space;
a free-space air-path through which optical radiation from the master unit travels before arriving at the client unit; and
a set of at least one optical beam-deflector through which the optical signal from at least one master unit travels before arriving at the respective client unit, each optical beam-deflector dedicated to the respective optical circuit on a semi-permanent basis.

2. An optical communications system comprising one or more optical circuits, each optical circuit comprising:
a set of at least one downstream client unit, each client unit comprising:
an optical receiver which accepts an incoming optical signal;
a photodetector associated with the respective optical receiver and responsive to electromagnetic radiation accepted by it;
a demodulator associated with the respective photodetector;
a set of at least one upstream master unit, each master unit semi-permanently optically coupled to the respective client unit, each master unit comprising:
an optical source operative to generate an optical signal characterized by a free-space wavelength less than about 10 micrometers;
a modulator operative to modulate the respective optical signal;
an optical beam director associated with the respective optical source and operating to direct the respective optical signal into free space;
a free-space air-path through which optical radiation from the master unit travels before arriving at the client unit; and
means for automatically orienting at least one optical element selected from the group consisting of: the set of optical beam directors and the set of optical receivers, thereby delivering the optical signal along the free space air-path between the respective master unit and the respective client unit.

3. The invention of claim 1 further comprising:
means for automatically orienting at least one optical element selected from the group consisting of: the set of optical beam directors, the set of optical receivers, and the set of optical beam-deflectors, thereby delivering the optical signal along the free-space air-path between the respective master unit and the respective client unit.

4. The invention of claim 1 or 2
wherein each upstream master unit comprises a respective first optical transceiver;
wherein each downstream client unit comprises a respective second optical transceiver;
wherein each first optical transceiver comprises the respective master unit optical source, modulator and optical beam director in combination with the following additional elements:
a master unit optical receiver which accepts a respective incoming optical signal;
a master unit photodetector associated with the respective master unit optical receiver and responsive to electromagnetic radiation accepted by it; and
a master unit demodulator associated with the respective master unit photodetector; and
wherein each second optical transceiver comprises the respective client unit optical receiver, photodetector and demodulator in combination with the following additional elements:
a client unit optical source operative to generate a respective client unit optical signal characterized by a free-space wavelength less than about 10 micrometers;
a client unit modulator operative to modulate the respective client unit optical signal; and
a client unit optical beam director associated with the respective client unit optical source and operating to direct the respective client unit optical signal into free space.

5. The invention of claim 1 or 2
wherein the set of master units comprises at least two master units located together in a master station; and
wherein the master station comprises a shared mechanical housing, a shared power supply, and a shared command-control-communication system for the at least two master units in the master station.

6. The invention of claim 1 or 3
wherein the set of optical beam-deflectors comprises at least two optical beam-deflectors located together in a relay station; and
wherein the relay station comprises a shared mechanical housing, a shared power supply, and a shared command-control-communication system for the at least two optical beam-deflectors in the master station.

7. An optical communications system alignment method to automatically establish a free-space optical circuit, said method comprising:
(a) providing a steerable optical transmitter component operative to generate an angularly-limited optical signal; a set (comprising zero, one, or more) of steerable optical beam-deflector components; and a steerable optical receiver component having angularly limited responsivity to incident optical signals; and
(b) automatically and sequentially aligning each of the components with a next component in the free-space optical circuit.

8. The method of claim 7 wherein the transmitter component and the receiver component being aligned are each included within separate steerable optical transceivers.

9. The method of claim 7 wherein the transmitter component comprises a photodetector; wherein each of the beam-deflector components and the receiver component comprises a respective retro-reflector which is initially active and responsive to incident light; and wherein (b) comprises
(b1) steering the optical signal with the transmitter component over a plurality of directions sufficient in solid-angular extent to cause the steered optical signal to reach the next component in the optical circuit;
(b2) terminating (b1) when the optical signal is reflected back from the retro-reflector of the next component to the photodetector of the transmitter component; and
(b3) inactivating the retro-reflector of the next component.

10. The method of claim 9 wherein (b) further comprises:
(b4) sending the optical signal from the transmitter component along the optical circuit to the receiver component;
(b5) steering the receiver component over a plurality of directions sufficient in solid-angular extent to encompass the optical beam of (b4); and
(b6) terminating (b5) when the receiver component receives the optical beam of (b4).

11. The method of claim 9 wherein the set of beam-deflector components comprises at least one beam-deflector component, and wherein (b) further comprises:
(b4) for each beam-deflector component, steering the optical signal with the respective beam-deflector component over a plurality of directions sufficient in solid-angular extent to cause the steered optical signal to reach the next component in the optical circuit;
(b5) terminating (b4) for the respective beam-deflector component when the optical signal is reflected back from the retro-reflector of the next component to the beam-deflector component that is being steered and thence back down the optical circuit to the photodetector of the transmitter component; and
(b6) inactivating the retro-reflector of the next component.

12. The method of claim 8 wherein each of the beam-deflector components and the receiver component comprises a respective retro-reflector which is initially active and responsive to incident light; and wherein (b) comprises:
(b1) steering the optical signal with the transmitter component over a plurality of directions sufficient in solid-angular extent to cause the steered optical signal to reach the next component in the optical circuit;
(b2) terminating (b1) when the optical signal is reflected back from the retro-reflector of the next component to the photodetector of the transmitter component; and
(b3) inactivating the retro-reflector of the next component.

13. The method of claim 12 wherein (b) further comprises:
(b4) sending the optical signal from the transmitter component along the optical circuit to the receiver component;
(b5) steering the receiver component over a plurality of directions sufficient in solid-angular extent to encompass the optical beam of (b4); and
(b6) terminating (b5) when the receiver component receives the optical beam of (b4).

14. The method of claim 12 wherein the set of beam-deflector components comprises at least one beam-deflector component, and wherein (b) further comprises:
(b4) for each beam-deflector component, steering the optical signal with the respective beam-deflector component over a plurality of directions sufficient in solid-angular extent to cause the steered optical signal to reach the next component in the optical circuit;
(b5) terminating (b4) for the respective beam-deflector component when the optical signal is reflected back from the retro-reflector of the next component to the beam-deflector component that is being steered and thence back down the optical circuit to the optical transceiver of the transmitter component; and
(b6) inactivating the retro-reflector of the next component.

15. The method of claim 12 wherein the transceiver that comprises the receiver component comprises a second transmitter operative to generate an angularly-limited second optical signal; and wherein (b) further comprises:
(b4) deactivating the first-mentioned optical signal of (a);
(b5) activating the second transmitter to generate the second optical signal; then
(b6) steering second optical signal over a plurality of directions sufficient in solid-angular extent to reach the previous component of the optical circuit; and
(b7) terminating (b6) when the second optical signal arrives at the photodetector of the transmitter component via the optical circuit.

16. The method of claim 7 wherein each of the beam-deflector components and the receiver component comprises a respective wide-angle photodetector; and wherein (b) comprises
(b1) steering the optical signal with the transmitter component over a plurality of directions sufficient in solid-angular extent to cause the steered optical signal to reach the next component in the optical circuit; and
(b2) terminating (b1) when the optical signal is detected by the wide-angle photodetector of the next component.

17. The method of claim 16 wherein (b) further comprises:
(b3) sending the optical signal from the transmitter component along the optical circuit to the receiver component;
(b4) steering the receiver component over a plurality of directions sufficient in solid-angular extent to encompass the optical beam of (b3); and
(b5) terminating (b4) when the receiver component receives the optical beam of (b3).

18. The method of claim 16 wherein the set of beam-deflector components comprises at least one beam-deflector component, and wherein (b) further comprises:
(b3) for each beam-deflector component, steering the optical signal with the respective beam-deflector component over a plurality of directions sufficient in solid-angular extent to cause the steered optical signal to reach the next component in the optical circuit;
(b4) terminating (b3) for the respective beam-deflector component when the optical signal is detected by the wide-angle photodetector of the next component.

19. The method of claim 8 wherein each of the beam-deflector components and the receiver component comprises a respective wide-angle photodetector; and wherein (b) comprises
(b1) steering the optical signal with the transmitter component over a plurality of directions sufficient in solid-angular extent to cause the steered optical signal to reach the next component in the optical circuit; and
(b2) terminating (b1) when the optical signal is detected by the wide-angle photodetector of the next component.

20. The method of claim 19 wherein (b) further comprises:
(b3) sending the optical signal from the transmitter component along the optical circuit to the receiver component;
(b4) steering the receiver component over a plurality of directions sufficient in solid-angular extent to encompass the optical beam of (b3); and
(b5) terminating (b4) when the receiver component receives the optical beam of (b3).

21. The method of claim 19 wherein the set of beam-deflector components comprises at least one beam-deflector component, and wherein (b) further comprises:
(b3) for each beam-deflector component, steering the optical signal with the respective beam-deflector component over a plurality of directions sufficient in solid-angular extent to cause the steered optical signal to reach the next component in the optical circuit;
(b4) terminating (b3) for the respective beam-deflector component when the optical signal is detected by the wide-angle photodetector of the next component.

22. The method of claim 19 wherein the transceiver that comprises the receiver component comprises a second transmitter operative to generate an angularly-limited second optical signal; and wherein (b) further comprises:
(b3) deactivating the first-mentioned optical signal of (a);
(b4) activating the second transmitter to generate the second optical signal; then
(b5) steering second optical signal over a plurality of directions sufficient in solid-angular extent to reach the previous component of the optical circuit; and
(b6) terminating (b5) when the second optical signal arrives at the photodetector of the transmitter component via the optical circuit.

23. The method of claim 9, 12, 16 or 19 wherein (b1) comprises steering the optical signal in at least two successive phases, wherein each successive phase is performed with a narrower beam width of the optical signal and over a smaller solid angle than the preceding phase.

24. The method of claim 10 or 13 wherein (b5) comprises steering the receiver component in at least two successive phases, wherein each successive phase is performed with a narrower receiver component beam width and over a smaller solid angle than the preceding phase.

25. The method of claim 17 or 20 wherein (b4) comprises steering the receiver component in at least two successive phases, wherein each successive phase is performed with a narrower receiver component beam width and over a smaller solid angle than the preceding phase.

26. The method of claim 11 or 14 wherein (b4) comprises steering the optical signal in at least two successive phases, wherein each successive phase is performed with a narrower beam width of the optical signal and over a smaller solid angle than the preceding phase.

27. The method of claim 15 wherein (b6) comprises steering the second optical signal in at least two successive phases, wherein each successive phase is performed with a narrower beam width of the optical signal and over a smaller solid angle than the preceding phase.

28. The method of claim 18 or 21 wherein (b3) comprises steering the optical signal in at least two successive phases, wherein each successive phase is performed with a narrower beam width of the optical signal and over a smaller solid angle than the preceding phase.

29. The method of claim 22 wherein (b5) comprises steering the second optical signal in at least two successive phases, wherein each successive phase is performed with a narrower beam width of the optical signal and over smaller solid angle than the preceding phase.

30. An optical communications system alignment method comprising:
(a) providing an optical transmitter operative to generate an angularly-limited optical signal characterized by a free-space wavelength less than about 10 micrometers, a target, and a steerable optical beam-deflector;
(b) aligning the optical signal from the transmitter with the optical beam-deflector;
(c) automatically redirecting the optical signal from the transmitter with the optical beam-deflector over a plurality of directions distributed over a solid angle greater than about 0.03 steradian; and
(d) automatically detecting when the redirected optical signal of (c) reaches the target.

31. The method of claim 30 wherein the optical beam-deflector operates autonomously during the re-directing of (c).

32. The method of claim 30 wherein the target comprises a second optical beam-deflector.

33. The method of claim 30 wherein the target comprises an optical receiver.

34. The method of claim 30 wherein the target of (a) comprises a retro-reflector, and wherein (d) comprises automatically detecting at the optical transmitter a retro-reflected portion of the optical signal that has traveled from the optical transmitter to the optical beam-deflector to the retro-reflector, back to the optical beam-deflector, and back to the optical transmitter.

35. The method of claim 30 wherein the target of (a) comprises a photodetector, and wherein (d) comprises automatically detecting at the target a re-directed portion of the optical signal that has traveled from the optical transmitter to the optical beam-deflector to the photodetector.

36. The method of claim 30 wherein the optical transmitter of (a) comprises a steerable optical beam director, and wherein (b) comprises:
(b1) automatically directing the optical signal from the transmitter with the optical beam director over a plurality of directions distributed over a solid angle greater than about 0.03 steradian; and
(b2) automatically detecting when the optical signal of (b1) reaches the optical beam-deflector.

37. The method of claim 30 wherein the optical beam-deflector is optically passive.

38. The method of claim 36 wherein the optical beam-deflector of (a) comprises a retro-reflector, and wherein (b2) comprises automatically detecting at the optical transmitter a retro-reflected portion of the optical signal that has traveled from the optical transmitter, to the retro-reflector, back to the optical transmitter.

39. The method of claim 36 wherein the optical beam-deflector of (a) comprises a photodetector, and wherein (b2) comprises automatically detecting at the optical beam-deflector a portion of the optical signal that has traveled from the optical transmitter to the photodetector.

40. The method of claim 30 or 36 wherein the target comprises a steerable optical receiver, and wherein the method further comprises:
(e) automatically steering the optical receiver after (d) over a plurality of directions distributed over a solid angle greater than about 0.03 steradian; and
(f) automatically detecting when the optical receiver is pointed at the optical beam-deflector.

41. The method of claim 30 or 36 wherein the target comprises a second steerable optical beam-deflector, wherein (a) further comprises providing an optical receiver, and wherein the method further comprises:
(e) automatically re-directing the optical signal from the transmitter and the first-mentioned optical beam-deflector with the second optical beam-deflector over a plurality of directions distributed over a solid angle greater than about 0.03 steradian; and
(f) automatically detecting when the multiply-redirected optical signal of (e) reaches the optical receiver.

42. The method of claim 41 wherein the optical receiver is steerable, and wherein the method further comprises:
(g) automatically steering the optical receiver after (f) over a plurality of directions distributed over a solid angle greater than about 0.03 steradian; and
(h) automatically detecting when the optical receiver is pointed at the optical beam-deflector.

43. The method of claim 30 wherein (c) is performed in at least two successive phases, wherein each successive phase is performed with a narrower beam-width and over a smaller solid angle than the immediately-preceding phase.

44. An optical communications system alignment method comprising:
(a) providing an optical transmitter operative to generate an angularly-limited optical signal characterized by a free-space wavelength less than about 10 micrometers, and a steerable optical receiver;
(b) automatically redirecting the optical signal from the transmitter over a plurality of directions distributed over a solid angle greater than about 0.03 steradian; and
(c) automatically detecting when the optical signal of (b) reaches the optical receiver.

45. The method of claim 44 wherein the optical receiver of (a) comprises a retro-reflector, and wherein (c) comprises automatically detecting at the optical transmitter a retro-reflected portion of the optical signal that has traveled from the optical transmitter to the retro-reflector, and back to the optical transmitter.

46. The method of claim 44 wherein the optical receiver of (a) comprises a photodetector, and wherein (c) comprises automatically detecting at the receiver a portion of the optical signal that has traveled from the optical transmitter to the photodetector.

47. The method of claim 44 wherein the method further comprises:
(e) automatically steering the optical receiver after (c) over a plurality of directions distributed over a solid angle greater than about 0.03 steradian; and
(f) automatically detecting when the optical receiver is pointed at the optical transmitter.

48. The method of claim 44 wherein (b) is performed in at least two successive phases, wherein each successive phase is performed with a narrower beam-width and over a smaller solid angle than the immediately-preceding phase.

49. An optical receiver system operative to accept an angularly-limited free-space optical signal characterized by a free-space wavelength less than about 10 micrometers, comprising:
a spatial filter limiting an acceptance angle of the incident optical signal to a value Δθ;
a spectral filter limiting an acceptance spectral passband of the incident optical signal to a value Δλ, wherein
(Δλ)·(Δθ)² is less than about 10⁻⁴ nm·rad²;
a photodetector associated with the respective optical receiver and responsive to electromagnetic radiation accepted by the spatial filter and the spectral filler;
a demodulator associated with the respective photodetector.

50. The invention of claim 49 wherein the optical receiver system comprises a steering system operative to steer the direction of its angularly-limited received beam over a 2-D region of greater than about 0.03 steradians.

51. The invention of claim 49 wherein Δλ is less than about 10 nanometer.

52. The invention of claim 49 wherein Δθ is less than about 1 milliradian.

53. The invention of claim 49 wherein Δλ is greater than about 0.5 nanometer.

54. The invention of claim 49 wherein Δθ is greater than about 0.03 milliradian.

55. An optical transceiver for an optical communications system, said transceiver comprising:
an optical source generating a transmitted optical signal comprising electromagnetic radiation of free-space wavelength less than about 10 micrometers;
a modulator associated with the optical source and operating to modulate the transmitted optical signal;
an optical beam director operative both to direct the optical signal from the source into free-space in an angularly-limited transmitted beam and also to collect a received optical beam;
a photodetector associated with the beam director and responsive to the received beam;
a demodulator associated with the photodetector; and
a retro-reflector mounted to overlap at least part of an optical aperture of the beam director, intercepting incident optical radiation before its transit through the beam director, the retro-reflector having an acceptance angle greater than about 0.03 steradian.

56. An optical transceiver for an optical communications system, said transceiver comprising:
an optical source generating a transmitted optical signal comprising electromagnetic radiation of free-space wavelength less than about 10 micrometers;
a modulator associated with the optical source and operating to modulate the transmitted optical signal;
an optical beam director operative both to direct the optical signal from the source into free-space in an angularly-limited transmitted beam and also to collect a received optical beam;
a photodetector associated with the beam director and responsive to the received beam;
a demodulator associated with the photodetector; and
a wide-angle photodetector mounted to overlap at least part of an optical aperture of the beam director, intercepting incident optical radiation before its transit through the beam director, the wide-angle photodetector having an acceptance angle of greater than about 0.03 steradian.

57. The invention of claim 55 or 56 wherein the optical transceiver also comprises:
a spatial filter limiting an acceptance angle of the received optical signal to a value Δθ; and
a spectral filter limiting an acceptance spectral passband of the received optical signal to a value Δλ, wherein
(Δλ)·(Δθ)² is less than about 10⁻⁴ nm·rad².

58. The invention of claim 57 wherein Δλ is less than about 10 nanometer.

59. The invention of claim 57 wherein Δθ is less than about 1 milliradian.

60. The invention of claim 57 wherein Δλ is greater than about 0.5 nanometer.

61. The invention of claim 57 wherein Δθ is greater than about 0.03 milliradian.

62. The invention of claims 55 or 56 wherein the optical transceiver comprises a steering system operative to steer the direction of the angularly-limited transmitted and received beams over a 2-D region of greater than about 0.03 steradian.

63. The invention of claim 62 wherein the optical transceiver includes an optical system operative to increase the beam-width of the angularly-limited transmitted and received beams during circuit alignment operations.

64. The invention of claim 62 wherein the steering system comprises a platform that carries the transceiver, said platform operative to mechanically point the transceiver with two degrees of angular freedom.

65. The invention of claim 62 wherein the steering system comprises:
a platform that carries the transceiver, said platform operative to mechanically point the transceiver through at least one degree of angular freedom; and
a beam-deflector operative to deflect the beams through at least one angular degree of freedom.

66. The invention of claim 62 wherein the steering system comprises:
a beam deflector positioned to intercept the beams and located on the free-space side of the beam director; and
means for controlling the direction of the beam deflector to optically steer the transmitted and received beams over a 2-D region of greater than about 0.03 steradian.

67. The invention of claim 62 wherein the steering system comprises:
at least two beam deflectors positioned to intercept the beams and located on the free-space side of the beam director; and
means for controlling the direction of each beam deflector in a respective direction, thereby steering the beams with the beam deflectors over a 2-D region of greater than about 0.03 steradian.

68. The invention of claim 62 wherein the steering system comprises an optically-active, non-mechanical beam-deflector with two degrees of angular freedom to optically steer the beams over a 2-D region of greater than about 0.03 steradian.

69. The invention of claim 62 wherein the steering system comprises a mechanical beam-deflection mechanism having at least one angular degree of freedom, and an optically-active, non-mechanical beam-deflection mechanism having at least one angular degree of freedom.

70. A transceiver module comprising a plurality of the steerable optical transceivers of claim 62, wherein the transceiver module comprises a shared mechanical housing, power supply, and command-control-communication system for the transceivers in the transceiver module.

71. A steerable optical beam-deflector comprising:
an optical system operative to deflect an angularly-limited, temporally-modulated optical beam from an incoming direction to an outgoing direction;
a steering system coupled with the optical system and operative to steer the optical beam over a plurality of outgoing directions distributed over a 2-D region of greater than about 0.03 steradian; and
a retro-reflector mounted to overlap at least part of an optical aperture of the optical system, said retro-reflector having an acceptance angle greater than about 0.03 steradian.

72. A steerable optical beam-deflector comprising:
an optical system operative to deflect an angularly-limited, temporally-modulated optical beam from an incoming direction to an outgoing direction;
a steering system coupled with the optical system and operative to steer the optical beam over a plurality of outgoing directions distributed over a 2-D region of greater than about 0.03 steradian; and
a wide-angle photodetector mounted to overlap at least part of an optical aperture of the optical system, said photodetector having an acceptance angle of greater than about 0.03 steradian.

73. The invention of claim 71 or 72 wherein the optical beam-deflector includes a system operative to change beam-width of the optical beam in the outgoing direction as compared to beam-width of the optical beam in the incoming direction.

74. The invention of claim 71 or 72, wherein the optical system comprises an optically-passive element, and wherein the steering system comprises a platform that carries the optically-passive element and is mechanically pointable with two degrees of angular freedom.

75. The invention of claim 74, wherein the optically-passive element comprises a mirror.

76. The invention of claim 71 or 72, wherein the optical system comprises an optically-passive element, and wherein the steering system comprises a platform that carries the optically-passive element and is mechanically pointable with at least one degree of angular freedom, and wherein the optical system further comprises a separate beam-deflector that is mechanically pointable with at least one angular degree of freedom.

77. The invention of claim 71 or 72, wherein the optical system comprises an optically-active, non-mechanical beam-deflector providing two degrees of angular freedom.

78. The invention of claim 71 or 72, wherein the optical system comprises an optically-passive, mechanical mechanism mounted for at least one angular degree of freedom and an optically-active, non-mechanical, beam-deflection mechanism providing at least one angular degree of freedom.

79. A beam-deflector module comprising a plurality of the steerable optical beam-deflectors of claim 71 or 72, wherein said module provides a shared mechanical housing, a shared power supply, and a shared command-control-communication system for the steerable beam-deflectors in the module.

80. The invention of claim 1, 55 or 56 wherein the optical source is characterized by an optical power less than about 5 milliwatt.

81. The invention of claim 1, 55 or 56 wherein the modulator for the optical source is coupled with and responsive to an Internet connection.
